(19) United States
(12) Patent Application Publication
(10) Pub. No.: US 2011/0259883 A1
(43) Pub. Date: Oct. 27, 2011

(54) Sectional plate for wall port incorporating reversible slide hood for wire management

(76) Inventor: Thomas J. DeCosta, Westport, MA (US)

(21) Appl. No.: 12/799,465

(22) Filed: Apr. 26, 2010

(51) Int. Cl. H02G 3/08; H02G 3/12

(52) U.S. Cl. 220/3.94

(57) ABSTRACT

A wall plates for electrical wiring, and more specifically, to a flush mounted Split Plate including a removable hood structure that can be mounted into the split plate in a plurality of configurations for the passage of cables and the like is disclosed. The wall plate includes a first plate section and second plate section that are mateable for easy separation and attachment. Both first and second plate sections include cantilever tab-like elements that extend from the ends of each plate section to join the plates. Both first and second plate sections further include openings disposed between the tab-like elements, the periphery of the openings slideably engaging channels at the base of the hood structure to secure the hood structure therein and to form an access opening when the first and second plates are joined.

### BACKGROUND OF THE INVENTION

1. Field of the Invention

The present invention relates to wall plates for electrical wiring, and more specifically, to a flush mounted Split Plate including a removable hood structure that can be mounted into the split plate in a plurality of configurations for the passage of cables and the like.

2. Description of Related Art

Wall plates to cover electrical devices mounted in gem boxes are well known in the art. Wall box mounted devices such as switches and receptacles are commonly provided with a wall plate serving both as a decorative cover for the device and to prevent access to the areas which contain the electrical wiring. Such wall plates are usually mounted upon the device by one or more screws passing through openings in the plate and received in a threaded aperture in the device. In some installations, two or more devices are mounted in side-by-side relation with a corresponding wall plate for each device.

Other types of wall plates include plates that can be interlocked at. their sides to provide for interchangeable wall panel assemblies for each configuration of electrical devices in any number of ganged gem boxes. Each wall plate includes specific openings to accommodate various electrical device apertures.

When communications devices such as stereo systems, televisions, computers, home theaters, etc. are to be placed in a room of a building structure, it is desirable to have the communication cable(s) leading to the equipment pass interiorly through the hollow wall structure to a position adjacent the equipment and then through an opening in the wall board to the equipment.

A wall plate having a cable access opening may be mounted in the wall opening for extending the cable into the room and forming a neater look about the wall opening. This also provides a neater look in the room by avoiding the lengths of cable from being exposed in the room.

In the past, wall plates usually were simply flat plastic plates mountable to the wall over the holes in the walls, and the wall plates had access holes passing the cable(s) into the room. This formed a more “finished look” to the cable entry. However, when the hole in the wall plate was not occupied by a cable, or when the cable occupied less than all the space of the access hole, a person could see through the access hole in the wall plate and possibly see into the wall structure.

Later, wall plates were developed that have a cable support extension or “nose shield” that protrudes from the wall plate into the room, with the nose shield having a vertically facing opening that communicates with the horizontally facing access hole in the wall plate. The cable was extended from the access opening and through the nose shield and into the room for connection to the audio/video system, etc. This type of wall plate having a nose-shield has met with popular use since the nose-shield provides a visual barrier through the opening in the wall plate.

More recently, some electrical appliances, particularly flat screen televisions, are mounted directly to the wall, so that the protruding nose of a wall plate interferes with mounting the television in flat abutment with the surface of the wall. The wall plate can be displaced laterally or vertically with respect to the flat screen television with the opening of the nose of the wall plate directed toward the television so as to provide the least exposure of the cable.

However, this arrangement does not hide the wall plate or the short run of the cable leading to the television set, and usually is considered visually unappealing. In this scenario there exists a need for a flush mounted plate including an inward extended opening that allows for the cable access opening to be split then reconnected, to allow for oversize wires and connectors to pass therethrough.

What is needed is a versatile plate that is useable for all anticipated scenarios. The present invention provides a separable plate and separable hood structure. The hood structure can be mounted to the plate in a plurality of configurations to support any, of the aforementioned applications.

### SUMMARY OF THE INVENTION

The foregoing and other problems are overcome, and other advantages are realized, in accordance with the disclosed, alternative embodiments of these teachings.

The present invention relates to wall plates for electrical wiring, and more specifically, to a flush mounted Split Plate including a removable hood structure that can be mounted into the split plate in a plurality of configurations for the passage of cables and the like. The plate is capable of being separated, then reconnected and securely interlocked at its mating end to allow for oversized connectors and fittings to be passed therethrough.

The invention comprises a first plate section and second plate section that are mateable for easy separation and attachment. Both first and second plate sections include cantilever tab-like elements that extend from the ends of each plate section to join the plates. Both first and second plate sections further include openings disposed between the tab-like elements, the periphery of the openings slideably engaging channels at the base of the hood structure to secure the hood structure therein and to form an access opening when the first and second plates are joined.

The first and second plate sections are flat and formed so as to be substantially coextensive with the wall to which it is to be mounted, and the hood structure can be alternatively mounted to the plate sections in a variety of configurations. Several configurations are available to the installer to provide several options for an attractive installation. The hood may be mounted such that the hood extends inward into a wall such that substantially no protrusion extends from the outer surface of the support plate into the room. This enables objects such as a flat screen television to be mounted substantially flush with the vertical wall surface.

Alternatively the plate may be mounted such that the hood extends outward from the wall. In either configuration the hood opening may be oriented upward or downward, thereby allowing selection of one of four possible mounting installations for added flexibility in routing cables through walls. In an alternative embodiment, the engagement channels at the base of the hood structure and the periphery of the openings of the first and second plate sections may be semi-circular allowing for the hood structure to be oriented 360 degrees within the secured plate. Also, the separable plate configuration provides an easy means of passing cables with oversized connectors through the passage hole prior to mating the plates and hood together. By using the sectional plate and hood of the present invention, the installer may be able to utilize existing installed electrical boxes and low voltage frames for routing low voltage cables and thereby avoid creating additional holes in the walls.

### BRIEF DESCRIPTION OF THE DRAWINGS

The foregoing aspects and other features of the present invention are explained in the following description, taken in connection with the accompanying drawings, wherein:

FIG. 1 is a drawing illustrating the principles of subject invention depicting a front perspective view of the separated plate halves, and slide hood prior to assembly.

FIG. 2 is a rear perspective view of the drawing of FIG. 1.

FIG. 3 is a front perspective view of a separated plate half.

FIG. 4 is a side view of the plate half of FIG. 3.

FIG. 5 is a bottom view of the plate half of FIG. 3.

FIG. 6 illustrates a perspective view of the slide hood of FIG. 1.

FIG. 7 is a front view of the slide hood of FIG. 6.

FIG. 8 is a side view of the slide hood of FIG. 6.

FIG. 9 is an alternate perspective view of the slide hood of FIG. 6.

FIG. 10 illustrates a bottom view of the slide hood engaging a plate half section.

FIG. 11 is a side perspective view of FIG. 10.

FIG. 12 illustrates the drawing of FIG. 1, after the separated plate halves, and slide hood are assembled.

FIG. 13 is a rear view of the illustration of FIG. 12.

FIGS. 14 and 15 illustrate an alternative embodiment of a slide hood engagement channel and corresponding sectional plate end section openings.

### DETAILED DESCRIPTION OF THE PREFERRED EMBODIMENTS

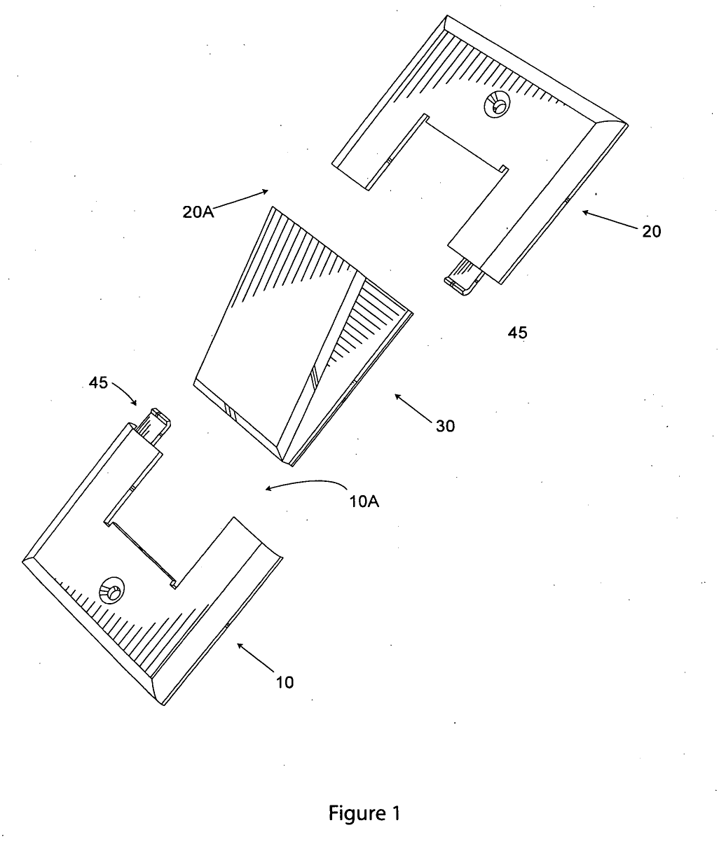

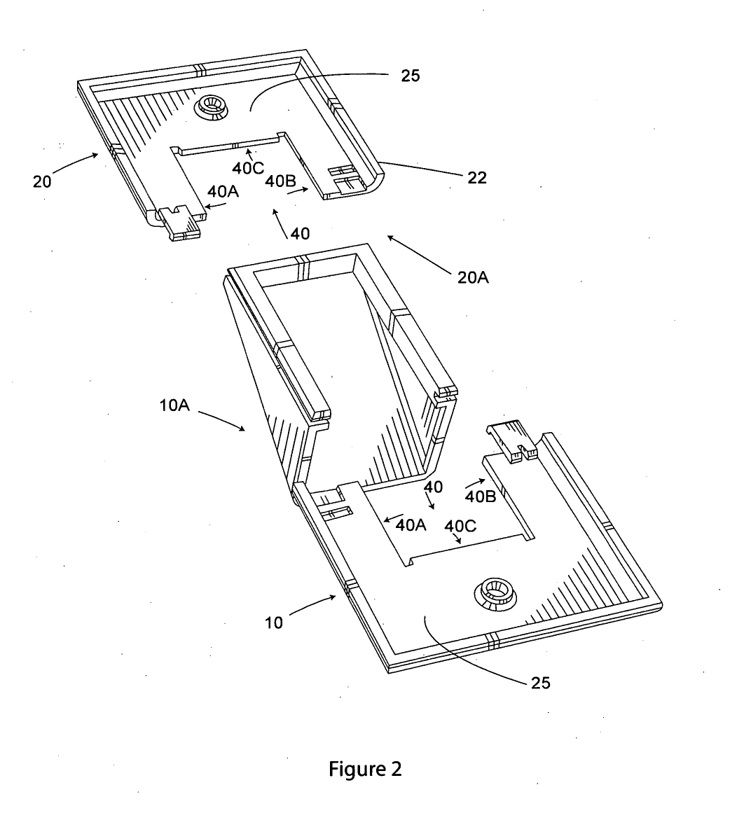

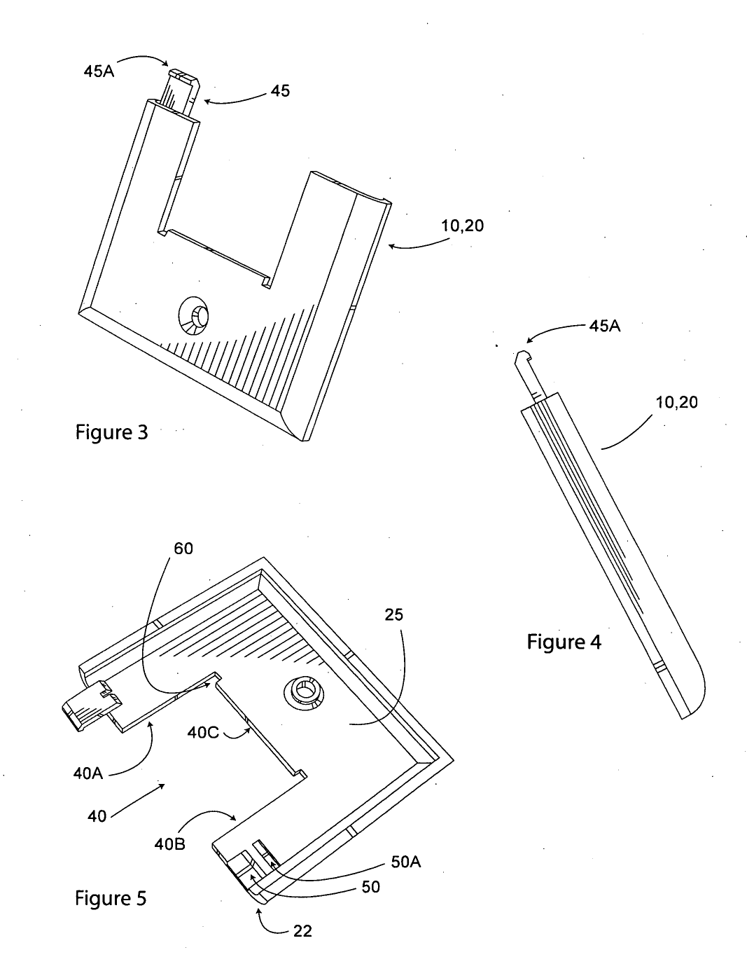

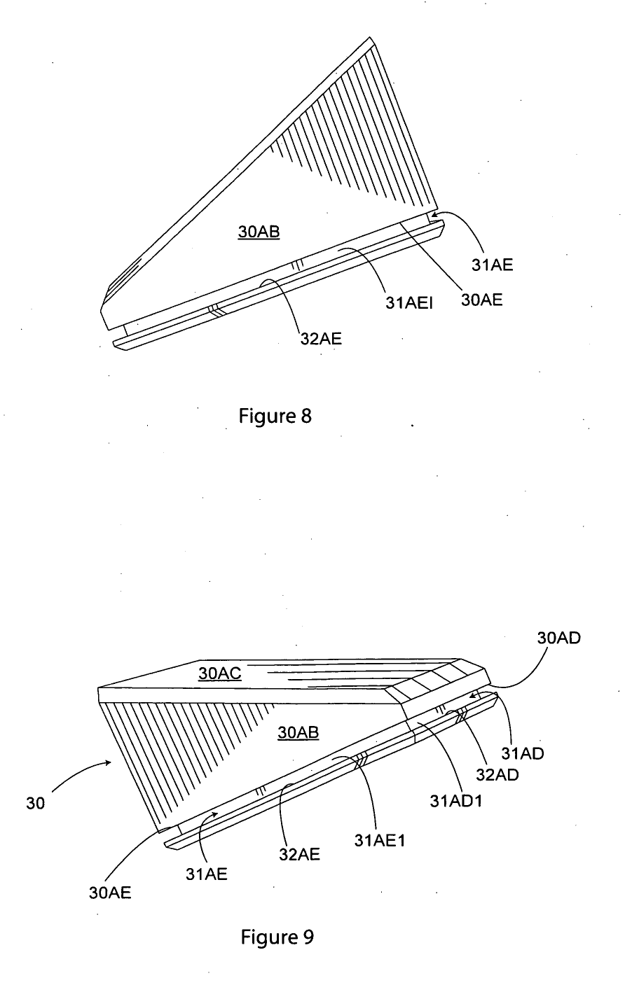

Referring to the drawings FIGS. 1 through 13, of the invention in detail, FIGS. 1 and 2 illustrate an embodiment of the present invention comprising a first plate section 10, a second plate section 20, and a slide hood 30 shown separately prior to assembly. In the disclosed embodiment both plates 10 and 20 are identical and mirror images of one another as illustrated in FIGS. 3-5. In the disclosed embodiment a slide hood is illustrated, however, any configuration workpiece for wire management or the like may be utilized when adapted for slidable engagement with the splitpate assembly as described below.

Referring to FIGS. 1 and 3-5, these first and second plate sections 10 and 20 are constructed for easy separation and engagement with each other. Plate sections and 20 utilize a cantilever tab-like element 45 that extends from the ends of each plate section 10 and 20 to join the plates. Engagement tabs are known in the art for separating and attaching plate sections to form a complete plate. In the illustrative embodiment, one example of engagement tabs 45 is disclosed, however it is understood that any engagement tab configuration may be utilized to join the sectional plates.

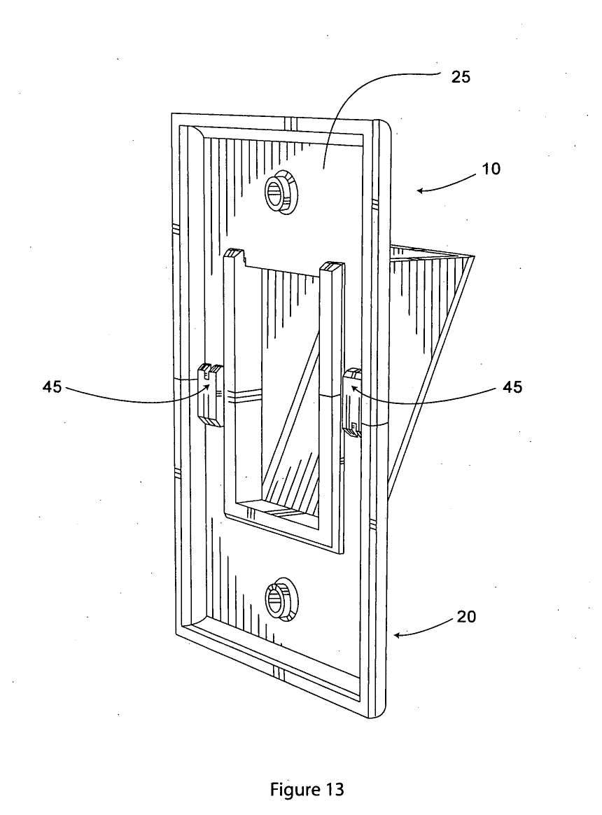

In this example, engagement tab 45 is identical for plate sections 10 and 20. Tab 45 includes a fixed outward extension of end sections 10A and 20A that is rigid while having limited flexibility for movement away from a normal position by application of force. Tab 45 further includes protuberance 45A, that engages and locks into cutout 50A (FIG. 5) of an opposing plate section when plates 10 and 20 are engaged (FIG. 13). Cutout 50A is of sufficient dimension to allow for protuberance 45A to securely fit therein when plates 10 and 20 are mated together.

Another example of engagement tabs relating to split plates is described in U.S. Pat. No. 7,112,744, issued Sep. 26, 2006, to applicant.

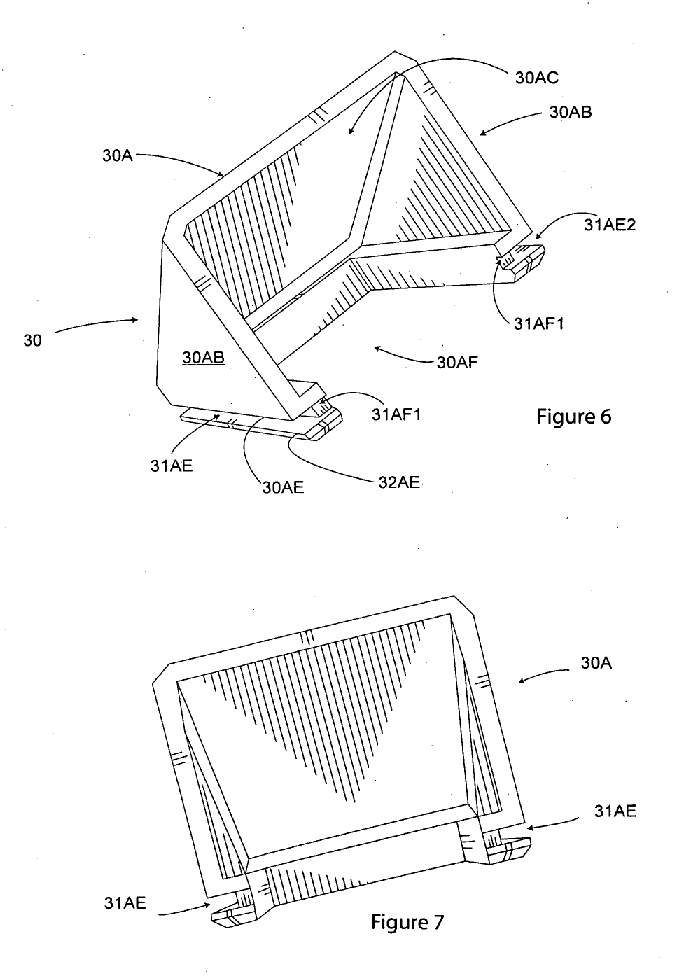

In the illustrative embodiment, Plate sections 10 and include a bottom surface 25 that includes a sidewall extension 22, as illustrated in FIG. 2. Extension 22 projects outward from bottom surface 25 extending around the periphery of the plate sections 10 and 20 forming a lip thereround. First plate section 10 includes an end section 10A that engages an end section 20A of second plate section 20. As illustrated in FIGS. 2 and 5, end sections 10A and 20A each include an opening 40, the peripheral edge of opening 40 includes side edges 40A and 40B and top edge 40C. As illustrated in FIGS. 6 and 9, Slide Hood 30 includes a nose portion 30A including sidewalls 30AB and an outer wall 30AC. A first lower edge 30AD is provided on the outer wall 30AC and a first lower edge 30AE is provided at the lower end of sidewalls 30AB. A substantially rectangular shaped nose portion opening 30AF is formed by the lower edges 30AD and 30AE of outer wall 30AC and sidewalls 30AB respectively.

A second lower edge 32AD is provided substantially parallel to first lower edge 30AD and a second lower edge 32AE is provided substantially parallel to first lower edge 30AE. Between and extending inward from first lower edge 30AD and second lower edge 32AD is a top channel 31AD having a top channel end wall 31AD1 and between and extending inward from first lower edge 30AE and second lower edge 32AE is a side channels 31AE having a side channel end wall 31AE1.

As illustrated in FIG. 6, at the periphery of the nose portion opening 30AF, is a hood engagement recess 31AE2. The recess is formed between first lower edge 30AE and second lower edge 32AE where edges 30AE and 32AE extend beyond side channel end wall edge 31AF1.

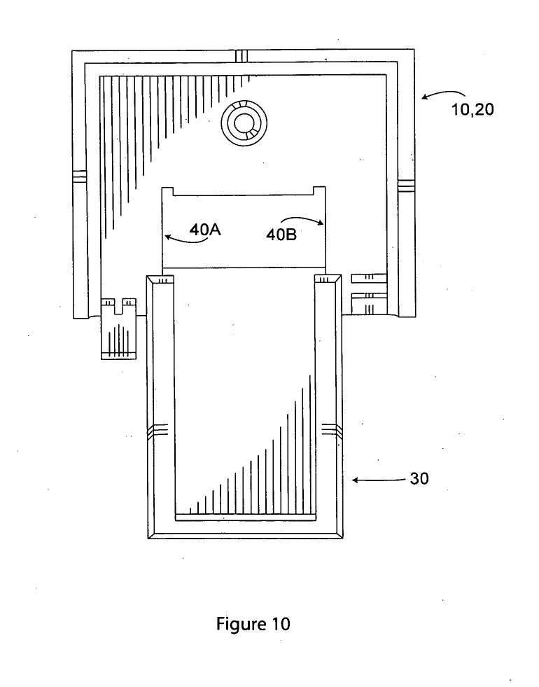

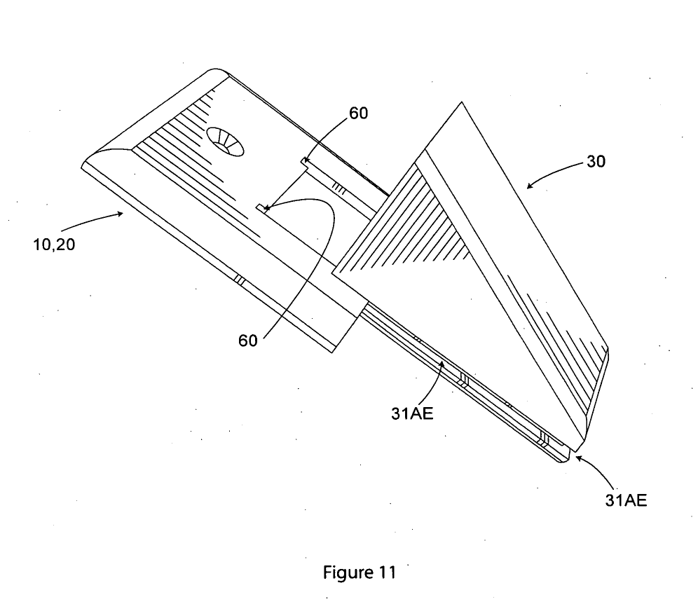

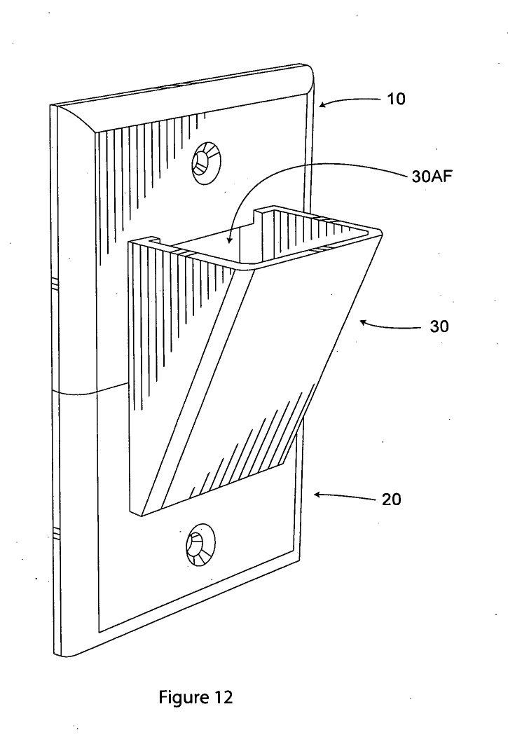

When the illustrated embodiment is assembled for use, side edges 40A and 40B, and a portion of plate sections 10 and 20 extending inward from side edges 40A and 40B, slideably engage hood 30 side channels 31AE as illustrated in FIGS. 10 and 11. The slidable engagement occurs up to a point when plate sections 10 and 20 respective end sections 10A and 20A are fully engaged and mated together as illustrated in FIGS. 12 and 13.

At one plate end, upon full engagement of plates 10 and 20, top edge 40C, and a portion of plate sections 10 and 20 extending inward from top edge 40C, engage hood 30 top channels 31AD. Channels 31AD and 31AE can be of any structure that allows for slideable engagement and securing of side edges 40A and 40B and top edge 40C therein. At the opposite end, upon full engagement of plates 10 and 20, hood engagement recess 31AE2 (FIG. 6) interlocks with plate recess 60, wherein end wall edge 31AF1 engages and locks into plate recess 60.

The length of the side channels 31AE, in the disclosed embodiment, are equal to the combined length of side edges 40A of plates 10 and 20. The plate sections 10 and 20 are capable of being separated, then reconnected and securely interlocked at their mating end. Hood 30 can be configured such that nose portion opening 30AF can be facing inward or outward from a mounting wall.

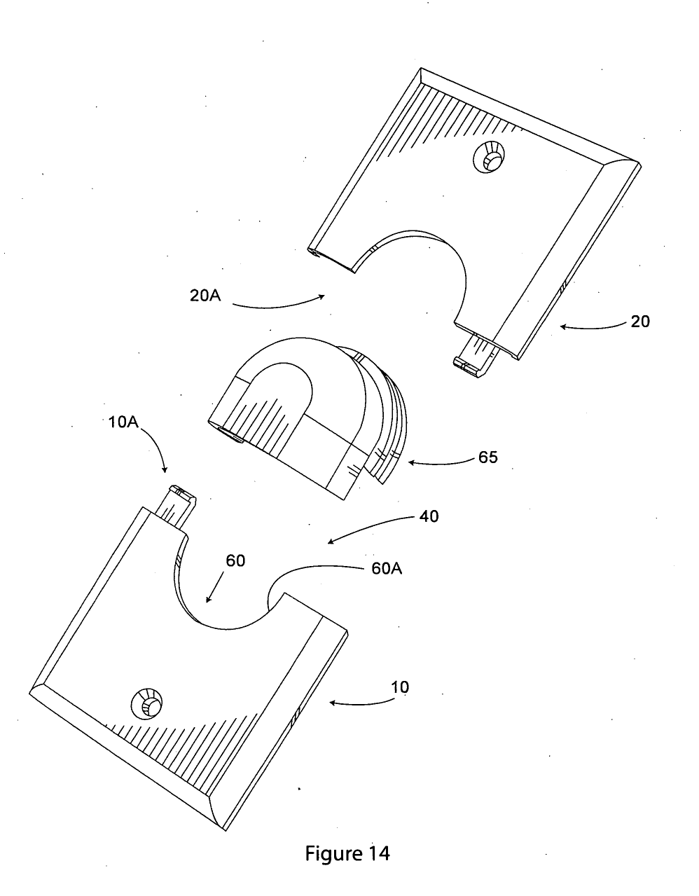

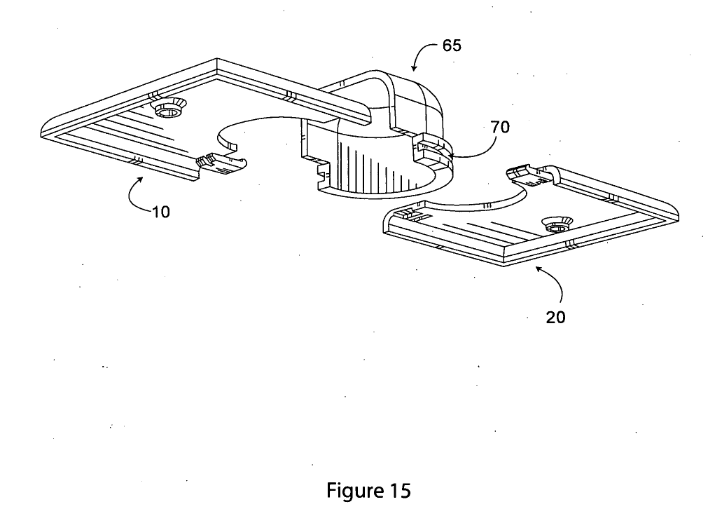

As illustrated in FIGS. 14 and 15, in an alternative embodiment, opening 40 may include a semicircular cutout 60 having a peripheral edge 60A. Hood structure 65 includes semi-circular engagement recess 70 that are engaged by a portion of plate sections 10 and 20 extending inward from peripheral edge 60A. The slidable engagement occurs up to a point when plate sections 10 and 20 respective end sections 10A and 20A are fully engaged and mated together. In this configuration Hood structure 65 is capable of being rotated to any 360 degree fixed position.

It is understood that the size of the plate sections and hood openings therein may be configured for a single or multiple ganged hood configurations according to a particular application. It is understood that these variations are within the scope of the present invention. It is further understood that although certain embodiments have been disclosed it is understood that changes and/or variations or equivalents to these embodiments are within the scope of the claims.

Although the description above contains many specificities, these should not be construed as limiting the scope of the embodiment but as merely providing illustrations of some of the presently preferred embodiments.

I claim:

1. A sectional plate comprising:
a first and second plate section, and
a removable center section having means for slideably engaging said first and second plate sections up to a point when said first and second plate sections are joined.

2. A sectional plate as in claim 1, wherein said first and second plate sections further comprise first and second end sections, said first and second end sections being mated together when said first and second plate sections are joined.

3. A sectional plate as in claim 2, wherein said removable center section has an opening therein.

4. A sectional plate as in claim 3, wherein said first and second end sections further comprise first and second openings disposed within said first and second end sections, said first and second openings in communication with said opening of said removable center section, when said first and second plate sections are joined.

5. A sectional plate as in claim 1, wherein said means for slideably engaging said center section to said first and second plate sections further comprises engagement channels disposed on said center section, said first and second plate sections slideably engaging said engagement channels.

6. A sectional plate as in claim 5, wherein said first and second plate sections further comprise first and second end sections, said first and second end sections further comprising first and second openings disposed within said first and second end sections, the periphery of said openings slideably engaging said engagement channels, said removable center section further comprising an opening therein, said center section opening in communication with said first and second openings.

7. A sectional plate as in claim 2, wherein said first and second end section further includes an engagement tab, said first and second end section further including a cutout, said engagement tab of said first end section securing into said cutout of said second end section and said engagement tab of said second end section securing into said cutout of said first end section when said first and second end sections are joined.

8. A sectional plate as in claim 6, wherein said center section further comprises an outer wall and a plurality of sidewalls, said engagement channels formed on said outer wall and said plurality of sidewalls, the periphery of said first and second openings slideably engaging said engagement channels to a point when said first and said second end sections are joined.

9. A sectional plate of claim 8, wherein said first and second openings each include a top edge and a plurality of side edges, said top edge of said first opening engaging said engagement channel of said outer wall and said engagement channels of said plurality of said sidewalls engaging said plurality of side edges of said first and second openings.

10. A sectional plate as in claim 6, wherein said first and second end section further includes an engagement tab, said first and second end section further including a cutout, said engagement tab of said first end section securing into said cutout of said second end section and said engagement tab of said second end section securing into said cutout of said first end section when said first and second end sections are joined.

11. A sectional plate as in claim 4, wherein said opening of said removable center section further comprises a cable support passage extending outward from said joined first and second plate sections.

12. A sectional plate comprising,
a first and second plate section, wherein said first and second plate sections further comprise first and second end sections, wherein said first and second end sections further comprise first and second openings disposed within said first and second end sections; a removable center section having an opening therein, said center section further comprising engagement channels for slideably engaging the periphery of said first and second plate section openings up to a point where said first and second end sections are joined, said first and second openings in communication with said opening of said removable center section, when said first and second plate sections are joined.
